(19) United States
(12) Patent Application Publication
(10) Pub. No.: US 2025/0094158 A1
(43) Pub. Date: Mar. 20, 2025

(54) Method, System, and Device for Managing Experimental Protocol

(71) Applicant: SHIMADZU CORPORATION, Kyoto-shi (JP)

(72) Inventor: Taichi TOMONO, Kyoto-shi (JP)

(21) Appl. No.: 18/697,696

(22) PCT Filed: Aug. 8, 2022
(86) PCT No.: PCT/JP2022/030225

§ 371 Date: Apr. 1, 2024

(30) Foreign Application Priority Data
Oct. 7, 2021 (JP) 2021-165216

(51) Int. Cl. G06F 8/65

(52) U.S. Cl. CPC G06F 8/65

(57) ABSTRACT

Efficiency of automatic execution of an experimental protocol is improved. A specific application executed in a terminal device sets a first parameter according to an amount of a sample contained in a specific container used in the experimental protocol. The specific application sets a second parameter according to a change in the amount of the sample in specific processing using the specific container in the experimental protocol. A controller automatically executes the experimental protocol based upon the first parameter and the second parameter. The specific application updates the first parameter based upon the second parameter.

### TECHNICAL FIELD

The present invention relates to a method, a system, and a device for managing an experimental protocol.

### BACKGROUND ART

Conventionally, a configuration for managing experimental data has been known. For example, NPL 1 discloses an experimental device control framework that allows easy and quick implementation of control of a liquid chromatograph, a liquid capillary electrophoresis device, and a gas chromatograph in a chromatography data system. In the experimental device control framework disclosed in NPL 1, a graphical user interface (GUI) is implemented through which a multisampler is used to designate which sample is to be introduced at which position in an experimental container (for example, a plate, a well, or a vial).

### CITATION LIST

### Non Patent Literature

NPL 1: Agilent Technologies, “Controlling the Agilent 1260 Infinity/1290 Infinity II Multisampler (G7167A/B) in Waters Empower 3 Environment” (https://www.agilent.com/cs/library/technicaloverviews/public/ICF_Empower Multisa mpler.pdf)

### SUMMARY OF INVENTION

### Technical Problem

When an experimental container containing at least one sample (a content) is used in an experimental protocol, the amount of each content may vary from the amount before execution of the experimental protocol. When the experimental container used in the experimental protocol is used again, it is necessary to update the amount of the content in the experimental container that is set for the configuration for managing the experimental data in order to accurately execute the experimental protocol in which the experimental container is used again. When a user updates the amount of the content in the experimental container one by one each time the experimental protocol ends, the efficiency of the automatic execution of the experimental protocol may decrease. However, no consideration is given in NPL 1 about an efficient update of the amount of the content in the experimental container.

The present invention has been made in order to solve the above-described problems, and an object of the present invention is to improve the efficiency of the automatic execution of an experimental protocol.

### Solution to Problem

A method according to an aspect of the present invention is to manage an experimental protocol through a specific application executed in a terminal device. The method includes the steps of: setting a first parameter of the specific application according to an amount of a sample contained in a specific container used in the experimental protocol; setting a second parameter of the specific application according to a change in the amount of the sample in specific processing using the specific container in the experimental protocol; controlling an experimental device to automatically execute the experimental protocol based upon the first parameter and the second parameter; and updating the first parameter based upon the second parameter after the specific processing ends.

A system according to another aspect of the present invention manages an experimental protocol. The system includes an experimental device, a terminal device, and a controller. The terminal device executes a specific application. The controller controls the experimental device. The specific application sets a first parameter of the specific application according to an amount of a sample contained in a specific container used in the experimental protocol. The specific application sets a second parameter of the specific application according to a change in the amount of the sample in specific processing using the specific container in the experimental protocol. The controller automatically executes the experimental protocol based upon the first parameter and the second parameter. The specific application updates the first parameter based upon the second parameter.

A device according to another aspect of the present invention manages an experimental protocol through a specific application. The device includes a storage unit and a processing unit. The storage unit stores a specific program that implements the specific application. The processing unit executes the specific program. The processing unit sets a first parameter of the specific application according to an amount of a sample contained in a specific container used in the experimental protocol. The processing unit sets a second parameter of the specific application according to a change in the amount of the sample in specific processing using the specific container in the experimental protocol. The processing unit controls an experimental device to automatically execute the experimental protocol based upon the first parameter and the second parameter. The processing unit updates the first parameter based upon the second parameter after the specific processing ends.

### Advantageous Effects of Invention

According to the method, the system, and the device of the present invention, after execution of the specific processing of the experimental protocol, the content in the specific container in the specific processing is automatically updated according to a change in the amount of this content in the specific container. According to the method, the system, and the device of the present invention, there is no need for the user to update the amount of the content in the specific container one by one each time the experimental protocol ends, which makes it possible to improve the efficiency of the automatic execution of the experimental protocol.

### BRIEF DESCRIPTION OF DRAWINGS

FIG. 1 is a block diagram illustrating a configuration of an automatic experimental management system according to an embodiment.

FIG. 2 is a block diagram illustrating a hardware configuration of a terminal device in FIG. 1.

FIG. 3 is a view illustrating an example of a GUI configuration of an experimental container management module of an experimental protocol management application in FIG. 1.

FIG. 4 is a view illustrating an example of a GUI configuration of a sample information setting window displayed when an addition button or a reference button in FIG. 3 is pressed.

FIG. 5 is a view illustrating the experimental container management module displayed when an OK button is pressed in the sample information setting window in FIG. 4.

FIG. 6 is a view illustrating the sample information setting window displayed when the reference button corresponding to a sample 1 is pressed in a sample setting window in FIG. 3.

FIG. 7 is a view illustrating a state in which settings related to a tube in FIG. 1 are displayed in the experimental container management module.

FIG. 8 is a view illustrating an example of a GUI configuration of an experimental protocol design module of the experimental protocol management application in FIG. 1.

FIG. 9 is a view illustrating a state in which processing is selected in an automatic experimental system window in FIG. 8.

FIG. 10 is a view illustrating a state in which a processing node corresponding to the processing selected in FIG. 9 is added to a protocol design window.

FIG. 11 is a view illustrating a state in which a sample container corresponding to a container node in FIG. 10 is designated.

FIG. 12 is a view illustrating a state in which designation of an experimental container corresponding to the container node in FIG. 11 is completed.

FIG. 13 is a view illustrating an oriented graph that is a design example of an experimental protocol.

FIG. 14 is a view illustrating a change-in-amount-of-sample setting window displayed when a user performs a GUI operation on the processing node in FIG. 13.

FIG. 15 is a view illustrating a state in which, after execution of the experimental protocol, the sample information setting window displays information about a sample whose change in the amount is set in the change-in-amount-of-sample setting window in FIG. 14.

FIG. 16 is a block diagram illustrating a hardware configuration of a server device in FIG. 1.

FIG. 17 is a flowchart illustrating a flow of an automatic experiment based on the experimental protocol executed in the automatic experimental management system in FIG. 1.

FIG. 18 is a block diagram illustrating a configuration of an automatic experimental management system according to a first modification of the embodiment.

FIG. 19 is a block diagram illustrating a hardware configuration of a terminal device in FIG. 18.

FIG. 20 is a block diagram illustrating a configuration of an automatic experimental system according to a second modification of the embodiment.

FIG. 21 is a block diagram illustrating a hardware configuration of a controller in FIG. 20.

### DESCRIPTION OF EMBODIMENTS

Hereinafter, an embodiment will be described in detail with reference to the accompanying drawings. In the following description, the same or corresponding portions in the accompanying drawings are denoted by the same reference characters, and the description thereof will not be repeated in principle.

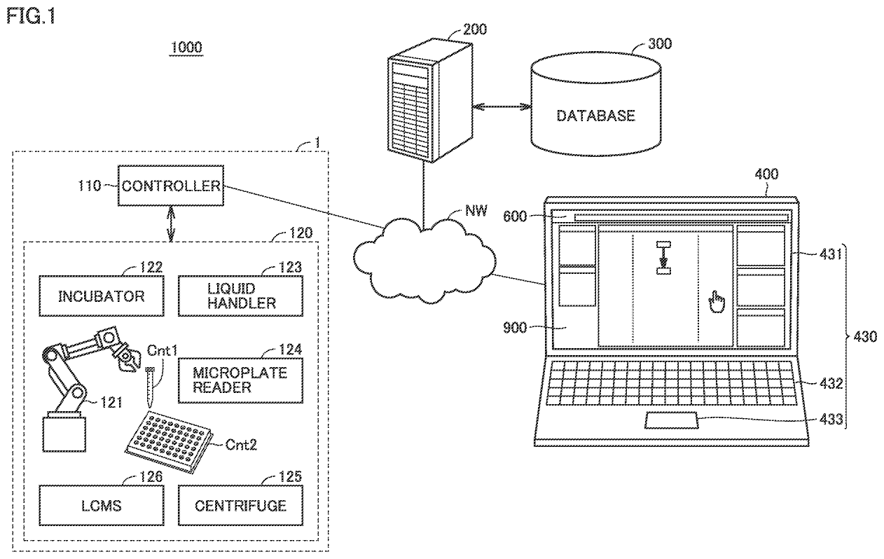

FIG. 1 is a block diagram illustrating a configuration of an automatic experimental management system 1000 according to an embodiment. As illustrated in FIG. 1, automatic experimental management system 1000 includes an automatic experimental system 1, a server device 200, a database 300, and a terminal device 400. Database 300 is connected to server device 200. For example, information about automatic experimental system 1, information about a sample (for example, a cell, a strain, or a reagent), information about an experimental container, information about a content in the experimental container, an experimental protocol, output data (results of an experiment) resulting from execution of the experimental protocol, and the like are registered in database 300. Terminal device 400 includes an input and output unit 430. Input and output unit 430 includes a display 431, a keyboard 432, and a touch pad 433. For example, terminal device 400 is a notebook computer, a personal computer, a smartphone, and a tablet. Automatic experimental system 1, server device 200, and terminal device 400 are connected to each other through a network NW. For example, network NW includes the Internet, a wide area network (WAN), or a local area network (LAN). The number of terminal devices connected to network NW may be greater than or equal to two, and the number of automatic experimental systems may be greater than or equal to two.

Server device 200 provides an experimental protocol management application 900 (a specific application) as a web application to terminal device 400. Experimental protocol management application 900 is displayed on display 431 through a Web browser 600 in terminal device 400. Experimental protocol management application 900 includes an experimental protocol design module and an experimental container management module. Keyboard 432 and touch pad 433 receive a graphical user interface (GUI) operation on experimental protocol management application 900 by a user. That is, by the GUI operation through keyboard 432 and touch pad 433, the user of terminal device 400 sets the content in the experimental container used in the experimental protocol. Also, by the GUI operation, the user of terminal device 400 selects an automatic experimental system in experimental protocol management application 900, and designs the experimental protocol executed by the automatic experimental system.

The experimental protocol defines processing order of at least one experimental device included in the automatic experimental system selected by the user. Terminal device 400 transmits the experimental protocol designed by the user to server device 200. Server device 200 transmits the experimental protocol to the automatic experimental system designated by the user of terminal device 400. When server device 200 is interposed between terminal device 400 that designs the experimental protocol and automatic experimental system 1 that executes the experimental protocol, this server device 200 can collectively manage a plurality of terminal devices 400 and a plurality of automatic experimental systems 1.

Automatic experimental system 1 includes a controller 110 and a plurality of experimental devices 120. Controller 110 controls the plurality of experimental devices 120 to automatically execute the experimental protocol from server device 200. The plurality of experimental devices 120 include a robot arm 121, an incubator 122, a liquid handler 123, a microplate reader 124, a centrifuge 125, and a liquid chromatograph mass spectrometer (LCMS) 126. The number of experimental devices included in the automatic experimental system may be one.

According to the order of a plurality of pieces of processing defined in the experimental protocol, robot arm 121 moves an experimental container containing a sample to the experimental device corresponding to each of the plurality of pieces of processing. The experimental container includes, for example, a tube Cnt1 or a microplate Cnt2. Tube Cnt1 has one sample accommodation space. Microplate Cnt2 has a plurality of wells as a plurality of sample accommodation spaces. A plurality of samples can be accommodated in each of the sample accommodation space of tube Cnt1 and the plurality of sample accommodation spaces of microplate Cnt2.

Incubator 122 cultures a cell while performing temperature control. Liquid handler 123 automatically distributes (dispenses) a certain amount of sample into each of a plurality of wells of the microplate. Microplate reader 124 performs measurements (for example, absorbance measurement and fluorescence intensity measurement) of an optical property of the sample in the microplate. Centrifuge 125 separates components of the sample by centrifugal force. LCMS 126 performs mass spectrometry for separating components of the sample separated by liquid chromatograph for each mass-to-charge ratio (m/z).

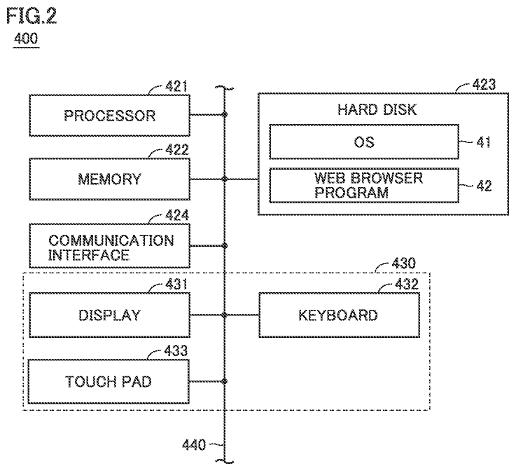

FIG. 2 is a block diagram illustrating a hardware configuration of terminal device 400 in FIG. 1. As illustrated in FIG. 2, terminal device 400 includes a processor 421, a memory 422 and a hard disk 423 as a storage unit, a communication interface 424, and input and output unit 430. These are communicably connected to each other through a bus 440.

Hard disk 423 is a non-volatile storage device. For example, hard disk 423 stores a program 41 of an operating system (OS) and a program 42 of a Web browser. In addition to the data shown in FIG. 2, for example, settings and outputs of various applications are stored in hard disk 423. Memory 422 is typically a volatile storage device such as a dynamic random access memory (DRAM).

Processor 421 includes a central processing unit (CPU). Processor 421 reads a program stored in hard disk 423 into memory 422 and executes the program. Processor 421 is connected to network NW through communication interface 424.

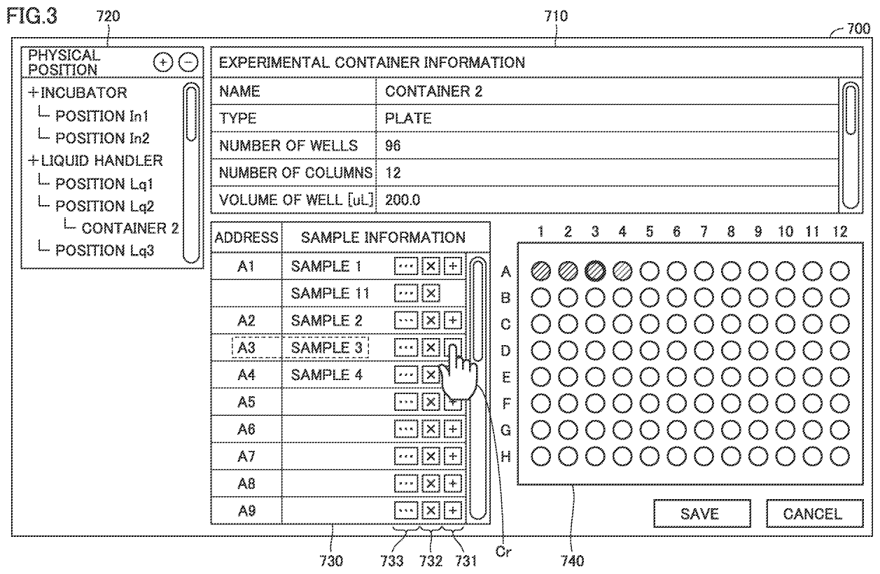

FIG. 3 is a view illustrating an example of a GUI configuration of an experimental container management module 700 of experimental protocol management application 900 in FIG. 1. FIG. 3 shows settings related to microplate Cnt2 (a specific container) in FIG. 1. As illustrated in FIG. 3, experimental container management module 700 includes an experimental container information window 710, a physical position window 720, a sample setting window 730, a sample accommodation space window 740, and a selection cursor Cr.

In experimental container information window 710, information about the experimental container is set. The information about the experimental container includes, for example, information about the name and the type of the experimental container and the volume of the sample accommodation space. In FIG. 3, the name and the type of microplate Cnt2 are set as “container 2” and “plate”, respectively. Further, the number of wells, the number of columns, and the volume of well (uL) each of which is information about the volume of the sample accommodation space of microplate Cnt2 are set at 96, 12, and 200.0, respectively.

In physical position window 720, the position of the experimental device at which the experimental container is disposed is set. Incubator 122 has positions In1 and In2 at which experimental containers can be disposed. Liquid handler 123 has positions Lq1, Lq2, and Lq3 at which experimental containers can be disposed. In FIG. 3, position Lq2 is set as a position at which microplate Cnt2 (“container 2”) is disposed.

In sample setting window 730, a sample contained in each of at least one accommodation space included in the experimental container is set. In sample setting window 730, a position (an address) of each of at least one accommodation space included in the experimental container and a sample contained at this position are set. In sample setting window 730, an addition button 731 is displayed at each address of the experimental container, and a delete button 732 and a reference button 733 are displayed for each sample. When the user presses addition button 731, a sample information setting window (not shown in FIG. 3) is displayed, and the sample set in the sample information setting window is added to an address corresponding to the pressed addition button 731. When the user presses delete button 732, the sample displayed in a row corresponding to the pressed delete button 732 is deleted from the address corresponding to this row. When the user presses reference button 733, a sample information setting window including information about the sample is displayed.

In sample accommodation space window 740, among the at least one accommodation space, the accommodation space located at the address at which the sample is set in sample setting window 730 is displayed in a highlighted manner. In sample accommodation space window 740, an opening in each of the at least one accommodation space is displayed in a plan view seen from the direction in which the sample is introduced. In FIG. 3, sample accommodation space window 740 shows twelve columns 1 to 12 of microplate Cnt2 and eight rows A to H. As shown in sample accommodation space window 740, 96 wells are formed in a matrix shape in microplate Cnt2. The address of each of these 96 wells in microplate Cnt2 is designated by a combination of a row identifier and a column identifier (for example, A1).

In sample setting window 730, samples 1 and 11 are set at an address A1, a sample 2 is set at an address A2, a sample 3 is set at an address A3, and a sample 4 is set at an address A4. In sample setting window 730, the row at address A3 is selected. As a result, in sample accommodation space window 740, the inside of the well at each of addresses A1 to A4 is shown in a highlighted manner while the outline of the well at address A3 is shown in a bold line. According to experimental protocol management application 900, the amount of the sample can be set in each sample accommodation space included in the experimental container.

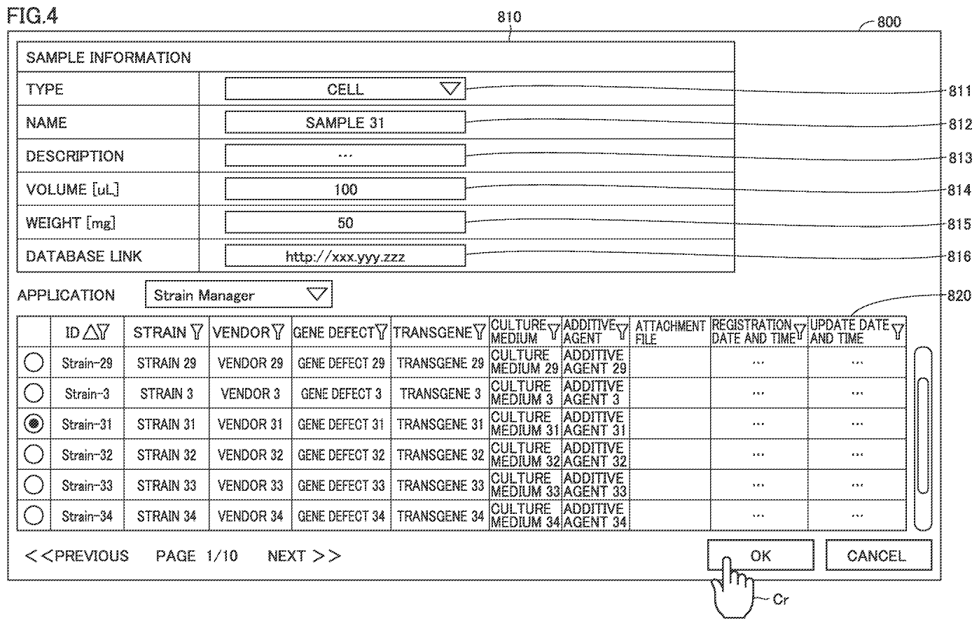

FIG. 4 is a view illustrating an example of a GUI configuration of a sample information setting window 800 displayed when addition button 731 or reference button 733 in FIG. 3 is pressed. As illustrated in FIG. 4, sample information setting window 800 includes a basic information window 810 and a strain window 820. FIG. 4 will be described with regard to a case where addition button 731 corresponding to address A3 is pressed in sample setting window 730 in FIG. 3.

Basic information window 810 includes a combo box 811 and edit boxes 812, 813, 814, 815, and 816. In combo box 811, a sample type (for example, a cell or a reagent) is designated. The name of the sample is input into edit box 812. A description of the sample is input into edit box 813. The volume (uL) of the sample is input into edit box 814. The weight (mg) of the sample is input into edit box 815. A uniform resource locator (URL) to a database including detailed information of the sample is input into edit box 816. In FIG. 4, “cell” is designated as the sample type, “sample 31” is input as the name of the sample, “100” is input as the volume of the sample, and “50” is input as the weight of the sample. Strain window 820 displays a plurality of strains registered in advance in experimental protocol management application 900. In FIG. 4, a strain 31 is selected. When the user presses an OK button, a plurality of sample information parameters of experimental protocol management application 900 are respectively set as a plurality of pieces of information about the sample set in basic information window 810. The plurality of sample information parameters are associated with identifiers of the sample set in basic information window 810.

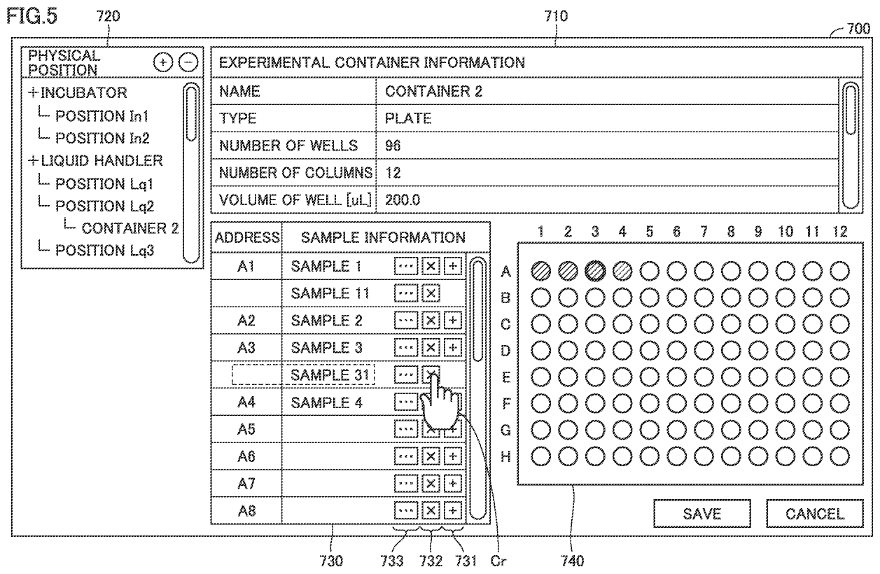

FIG. 5 is a view illustrating experimental container management module 700 displayed when the OK button is pressed in sample information setting window 800 in FIG. 4. As illustrated in FIG. 5, sample 31 is added to address A3 in sample setting window 730. When delete button 732 corresponding to sample 31 is pressed, sample setting window 730 is displayed in the same manner as sample setting window 730 in FIG. 3.

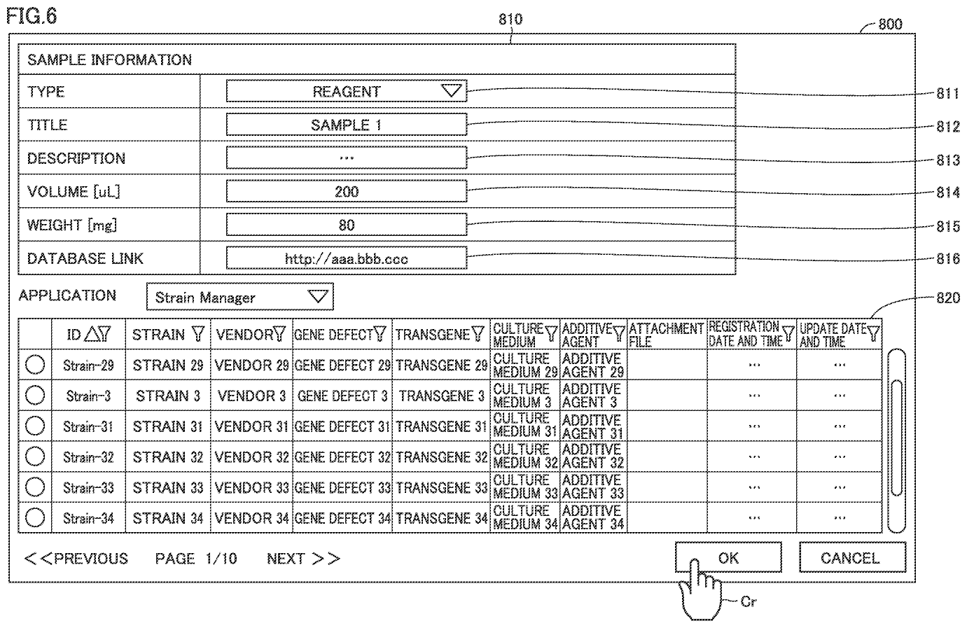

FIG. 6 is a view illustrating sample information setting window 800 displayed when the reference button corresponding to sample 1 is pressed in sample setting window 730 in FIG. 3. As illustrated in FIG. 6, for sample 1, “reagent” is set as the type, “200” is set as the volume, and “80” is set as the weight.

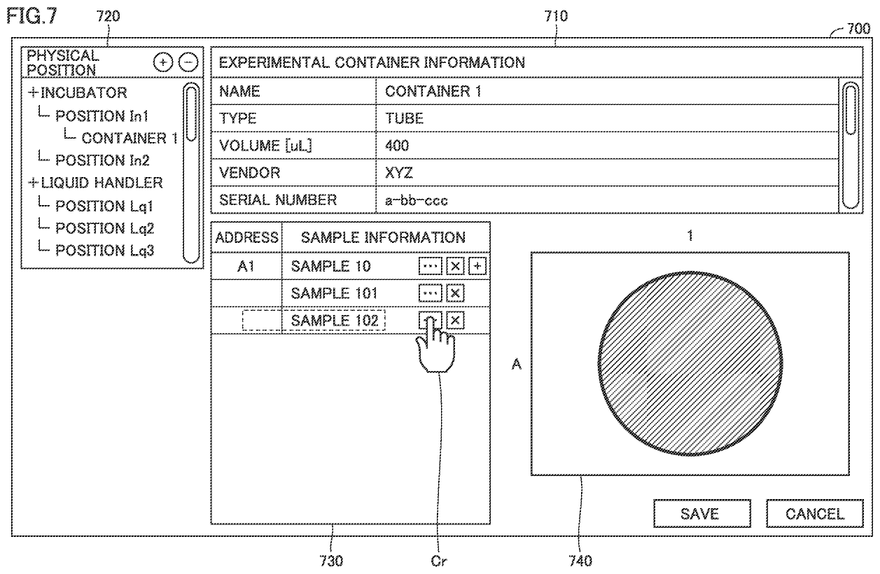

FIG. 7 is a view illustrating a state in which settings related to tube Cnt1 (a specific container) in FIG. 1 are displayed in experimental container management module 700. As illustrated in FIG. 7, in experimental container information window 710, for tube Cnt1, “container 1” is set as the name, “tube” is set as the type, and “400” is set as the volume. In physical position window 720, position In1 of incubator 122 is set as a position at which tube Cnt1 is disposed. In sample setting window 730, samples 10, 101, and 102 are set at address A1, and a row corresponding to sample 102 is selected. Since tube Cnt1 has one sample accommodation space, one sample accommodation space is displayed in sample accommodation space window 740.

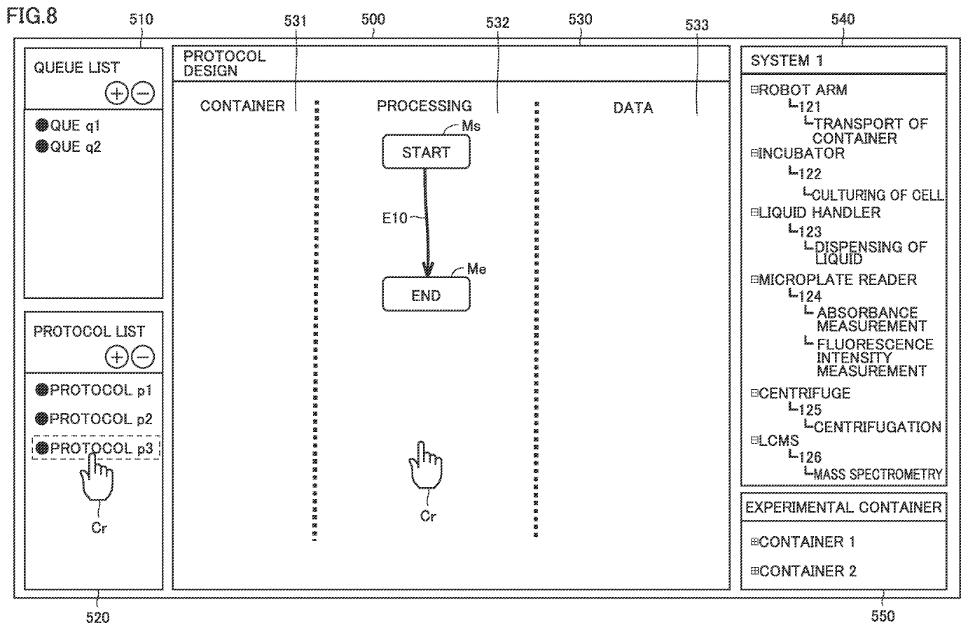

FIG. 8 is a view illustrating an example of a GUI configuration of an experimental protocol design module 500 of experimental protocol management application 900 in FIG. 1. As illustrated in FIG. 8, experimental protocol design module 500 includes a queue list window 510, a protocol list window 520, a protocol design window 530, an automatic experimental system window 540, an experimental container window 550, and a selection cursor Cr.

Queue list window 510 displays queues in which a plurality of protocols are arranged in order. In FIG. 8, queue list window 510 displays queues q1 and q2. Protocol list window 520 displays experimental protocols. In FIG. 8, experimental protocols p1, p2, and p3 are displayed in protocol list window 520, and experimental protocol p3 is selected.

In protocol design window 530, the experimental protocol is designed in the form of an oriented graph. In the oriented graph, a connection relation between a plurality of nodes is defined as an edge. The oriented graph is stored as graph structure data according to a predetermined structured data format. For example, eXtensible Markup Language (XML) or JavaScript (registered trademark) Object Notation (Json) can be cited as the structured data format. The plurality of nodes each selectable as a vertex of the oriented graph are formed as GUIs and include container nodes, processing nodes, and data nodes. The container node is a node corresponding to a container (an experimental container) containing a sample processed by at least one experimental device. The processing node is a node corresponding to processing by each device included in the automatic experimental system. The data node is a node corresponding to the output data of the processing of the experimental device.

Protocol design window 530 is divided into a container region 531, a processing region 532, and a data region 533. In an initial state in which designing of the experimental protocol is started, processing region 532 shows a start node Ms representing a start of the experimental protocol, an end node Me representing an end of the experimental protocol, and an edge E10 extending from start node Ms to end node Me.

Automatic experimental system window 540 displays processing executable by each of at least one experimental device included in the automatic experimental system selected by the use. In FIG. 8, automatic experimental system 1 is selected. “Transport of container” is displayed as the processing executable by robot arm 121. “Culturing of cell” is displayed as the processing executable by incubator 122. “Dispensing of liquid” is displayed as the processing executable by liquid handler 123. “Absorbance measurement” and “fluorescence intensity measurement” are displayed as the processing executable by microplate reader 124. “Centrifugation” is displayed as the processing executable by centrifuge 125. “Mass spectrometry” is displayed as the processing executable by LCMS 126.

Experimental container window 550 displays the experimental container set in experimental container management module 700 in FIG. 3. In FIG. 8, tube Cnt1 (“container 1”) and microplate Cnt2 (“container 2”) are displayed.

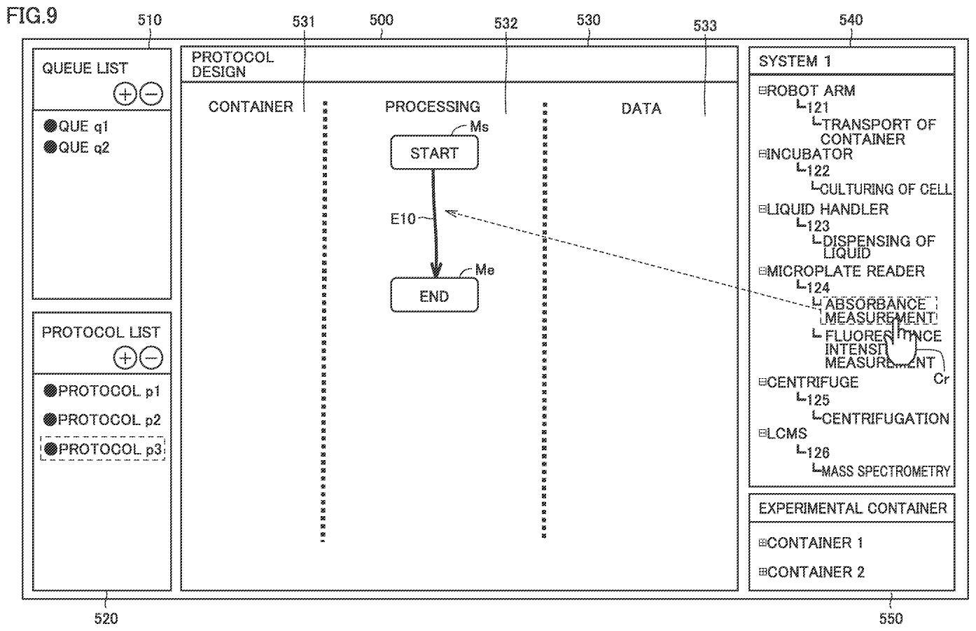

FIG. 9 is a view illustrating a state in which processing is selected in automatic experimental system window 540 in FIG. 8. As illustrated in FIG. 9, by the user, the “absorbance measurement” is selected in automatic experimental system window 540 and dragged between start node Ms and end node Me.

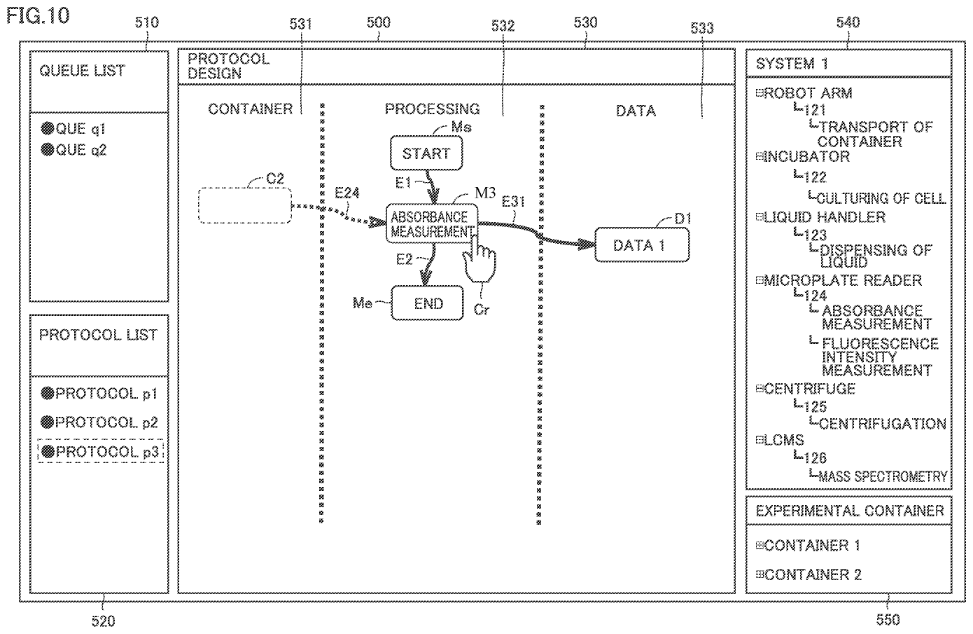

FIG. 10 is a view illustrating a state in which the processing node corresponding to the processing selected in FIG. 9 is added to protocol design window 530. As illustrated in FIG. 10, a processing node M3 corresponding to “absorbance measurement” is added and selected between start node Ms and end node Me. According to the addition of processing node M3, a container node C2 and a data node D1 are automatically added to container region 531 and data region 533, respectively.

Start node Ms and processing node M3 are connected by an edge E1 extending from start node Ms to processing node M3. Processing node M3 and end node Me are connected by an edge E2 extending from processing node M3 to end node Me. Container node C2 and processing node M3 are connected by an edge E24 extending from container node C2 to processing node M3. Processing node M3 and data node D1 are connected by an edge E31 extending from processing node M3 to data node D1. Edge E24 indicates that the experimental container corresponding to container node C2 is input to the processing corresponding to processing node M3. Edge E31 indicates that the output data of the processing corresponding to processing node M3 corresponds to data node D1. According to the addition of the processing node, the container node and the data node that are connected to the processing node are automatically added, whereby the experimental protocol can be efficiently designed. In FIG. 10, since the sample container corresponding to container node C2 is not designated, container node C2 and edge E24 each are indicated by a dotted line.

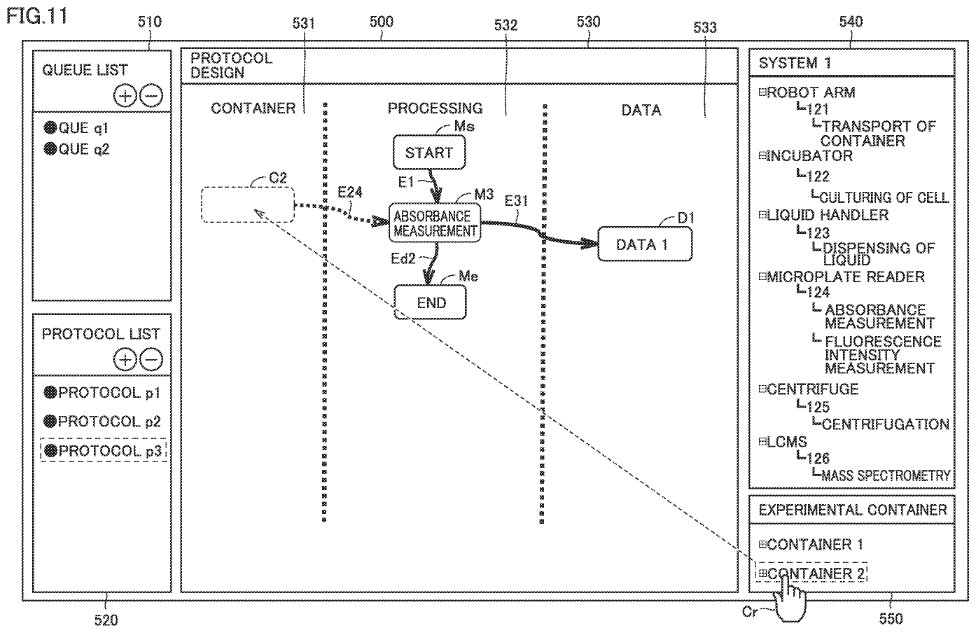

FIG. 11 is a view illustrating a state in which the sample container corresponding to container node C2 in FIG. 10 is designated. As illustrated in FIG. 11, by the user, “container 2” is selected in experimental container window 550 and dragged to container node C2.

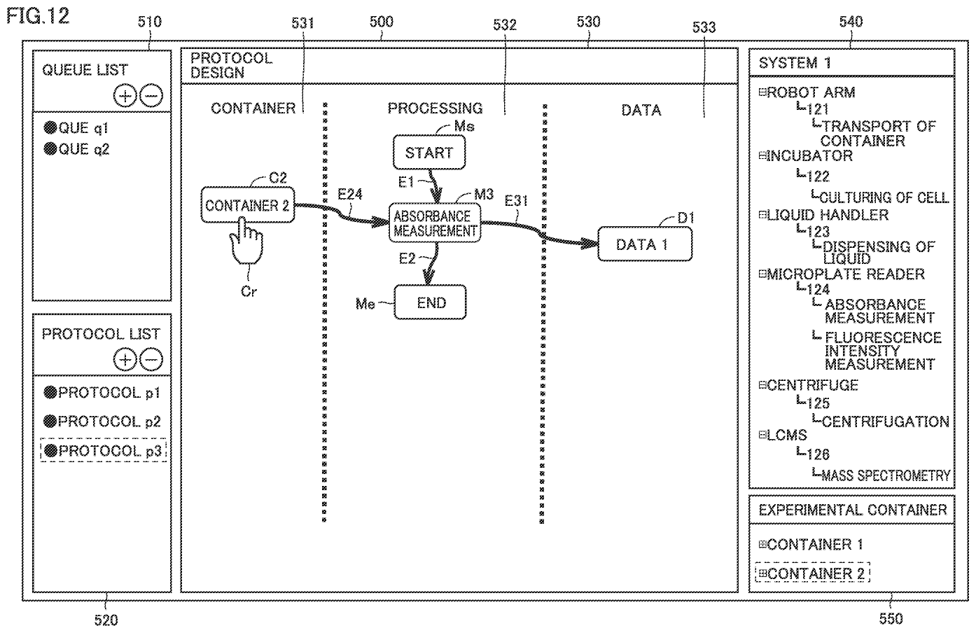

FIG. 12 is a view illustrating a state in which designation of the experimental container corresponding to container node C2 in FIG. 11 is completed. As illustrated in FIG. 12, container node C2 is selected, and container node C2 and edge E24 are indicated by solid lines.

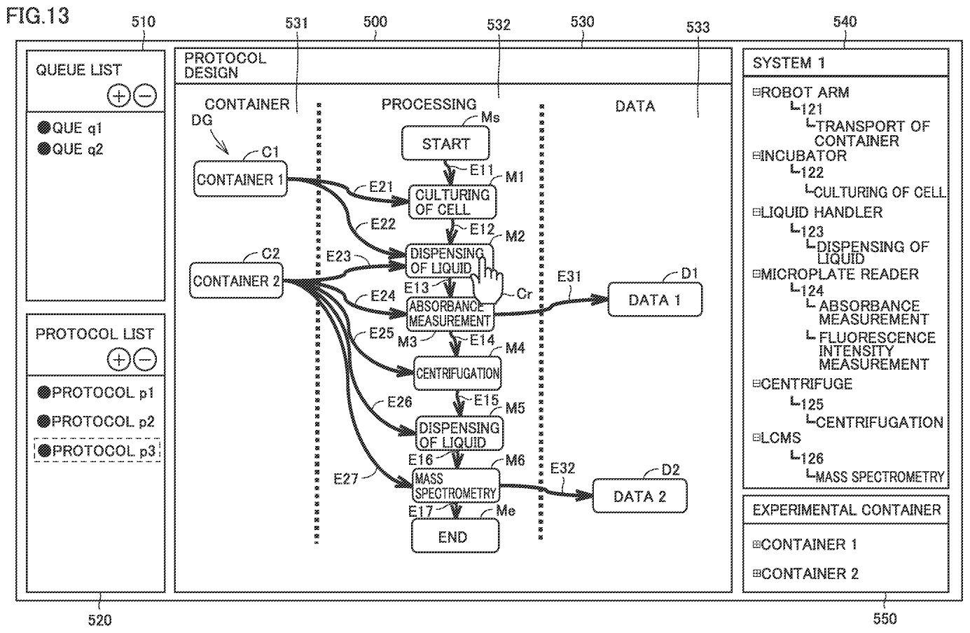

FIG. 13 is a view illustrating an oriented graph DG that is a design example of experimental protocol p3. Oriented graph DG represents the experimental protocol completed by further adding a design to the state shown in FIG. 12. As illustrated in FIG. 13, oriented graph DG includes start node Ms, end node Me, processing nodes M1, M2, M3, M4, M5, and M6, container nodes C1, C2, and data nodes D1, D2. Processing nodes M1, M2, M3, M4, M5, and M6 correspond to “culturing of cell”, “dispensing of liquid” (specific processing), “absorbance measurement”, “centrifugation”, “dispensing of liquid”, and “mass spectrometry”, respectively, shown in automatic experimental system window 540.

Start node Ms and processing node M1 are connected by an edge E11 extending from start node Ms to processing node M1. Processing nodes M1, M2 are connected by an edge E12 extending from processing node M1 to processing node M2. Processing nodes M2, M3 are connected by an edge E13 extending from processing node M2 to processing node M3. Processing nodes M3, M4 are connected by an edge E14 extending from processing node M3 to processing node M4. Processing nodes M4, M5 are connected by an edge E15 extending from processing node M4 to processing node M5. Processing nodes M5, M6 are connected by an edge E16 extending from processing node M5 to processing node M6. Processing node M6 and end node Me are connected by an edge E17 extending from processing node M6 to end node Me.

Container node C1 and processing node M1 are connected by an edge E21 extending from container node C1 to processing node M1. Container node C1 and processing node M2 are connected by an edge E22 extending from container node C1 to processing node M2.

Container node C2 and processing node M2 are connected by an edge E23 extending from container node C2 to processing node M2. Container node C2 and processing node M3 are connected by an edge E24 extending from container node C2 to processing node M3. Container node C2 and processing node M4 are connected by an edge E25 extending from container node C2 to processing node M4. Container node C2 and processing node M5 are connected by an edge E26 extending from container node C2 to processing node M5. Container node C2 and processing node M6 are connected by an edge E27 extending from container node C2 to processing node M6.

Processing node M3 and data node D1 are connected by an edge E31 extending from processing node M3 to data node D1. Processing node M6 and data node D2 are connected by an edge E32 extending from processing node M6 to data node D2.

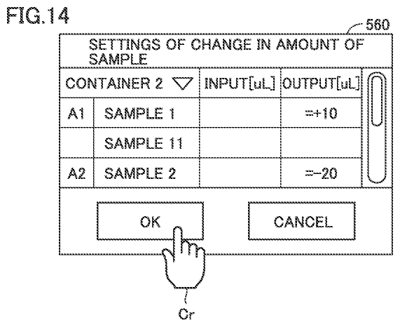

FIG. 14 is a view illustrating a change-in-amount-of-sample setting window 560 (a specific GUI) displayed when the user performs a GUI operation (for example, double click) on processing node M2 (a specific node) in FIG. 13. In change-in-amount-of-sample setting window 560, the change in the amount of the content in the experimental container used in the double-clicked processing node is set. FIG. 14 shows the state in which container 2 is selected from among tube Cnt1 (container 1) and microplate Cnt2 (container 2) used in processing node M2, and the change in the amount of the content in container 2 is set. In experimental protocol management application 900, the processing included in the experimental protocol is represented as a processing node included in the oriented graph, and thereby, the change in the amount of the content in the experimental container can be readily set through change-in-amount-of-sample setting window 560 displayed by the GUI operation on the processing node. Further, in the experimental protocol designed as an oriented graph, the container node corresponding to the experimental container and the processing node corresponding to the processing using the experimental container are connected by an edge, and thereby, the correspondence relation between the experimental container and the processing using this experimental container can be readily grasped.

As illustrated in FIG. 14, an increase of 10 uL is set as a change in an amount of sample 1 at address A1. Also, a decrease of 20 uL is set as a change in an amount of sample 2 at address A2. When the user presses the OK button, at least one change-in-amount parameter (the second parameter) of experimental protocol management application 900 is respectively set at the change in the amount of at least one sample set in change-in-amount-of-sample setting window 560. At least one change-in-amount parameter is associated with the identifier of the experimental container selected in change-in-amount-of-sample setting window 560.

After the change in the amount of the content contained in the experimental container is set by change-in-amount-of-sample setting window 560 in FIG. 14, an experimental protocol including processing (specific processing) using the experimental container is executed. Among the plurality of sample information parameters of each of at least one sample contained in the experimental container used in the specific processing, a parameter (the first parameter) related to the amount is automatically updated by experimental protocol management application 900 based upon the change-in-amount parameter set for this sample in change-in-amount-of-sample setting window 560 after the specific processing ends.

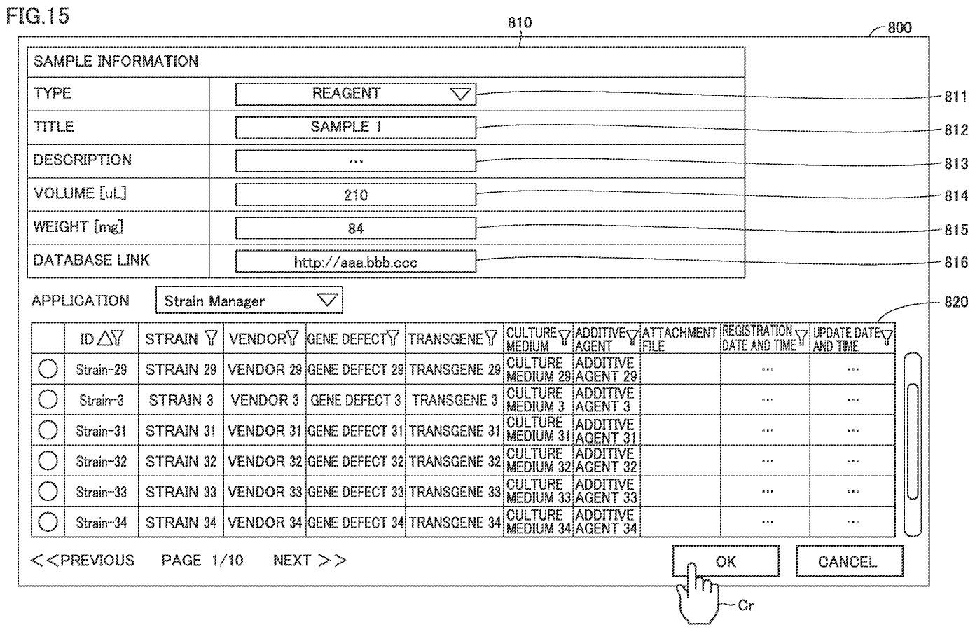

FIG. 15 is a view illustrating a state in which, after execution of the experimental protocol, sample information setting window 800 displays information about sample 1 whose change in the amount is set in change-in-amount-of-sample setting window 560 in FIG. 14. Referring also to FIGS. 6, 14, and 15, the volume and the weight shown in FIG. 15 are increased by 10 UuL and 4 mg, respectively, from the volume and the weight shown in FIG. 6. Each of the volume and the weight shown in FIG. 15 is increased in amount by 5% (= 10/200) from those shown in FIG. 6 based on the increase of 10 uL relative to sample 1 set in FIG. 14.

In automatic experimental management system 1000, after execution of the specific processing of the experimental protocol, the content in the experimental container in the specific processing is automatically updated according to the change in the amount of this content in the experimental container. According to automatic experimental management system 1000, there is no need for the user to update the amount of the content in the experimental container one by one each time the experimental protocol ends, and thus, the efficiency of the automatic execution of the experimental protocol can be improved.

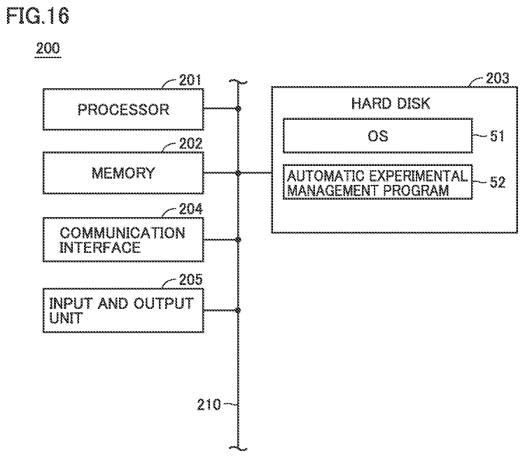

FIG. 16 is a block diagram illustrating a hardware configuration of server device 200 in FIG. 1. As illustrated in FIG. 16, server device 200 includes a processor 201, a memory 202 and a hard disk 203 as a storage unit, a communication interface 204 as a communication unit, and an input and output unit 205. These are communicably connected to each other through a bus 210.

Hard disk 203 is a non-volatile storage device. For example, hard disk 203 stores a program 51 of an operating system (OS) and an automatic experimental management program 52. In addition to the data in FIG. 16, for example, settings and outputs of various applications are stored in hard disk 203. Memory 202 is typically a volatile storage device such as a dynamic random access memory (DRAM).

Processor 201 includes a central processing unit (CPU). Processor 201 reads a program stored in hard disk 203 into memory 202 and executes the program to implement various functions of server device 200. For example, processor 201 executing automatic experimental management program 52 provides experimental protocol management application 900 to terminal device 400. Processor 201 is connected to network NW through communication interface 204.

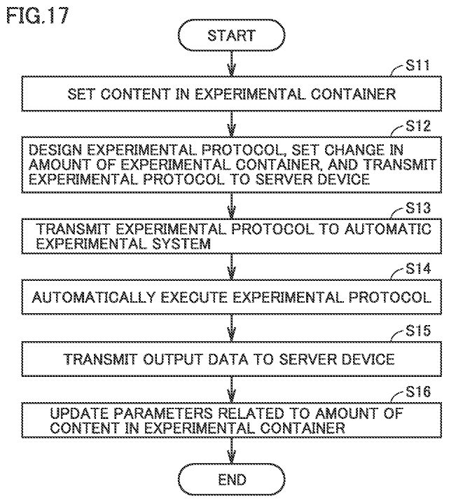

FIG. 17 is a flowchart illustrating a flow of an automatic experiment based on the experimental protocol performed in automatic experimental management system 1000 in FIG. 1. As illustrated in FIG. 17, in S11, terminal device 400 sets the content in the experimental container. In S12, terminal device 400 designs the experimental protocol in the form of an oriented graph, sets the change in the amount of the content in the experimental container used in the experimental protocol, and transmits the experimental protocol to server device 200. In S13, server device 200 transmits the experimental protocol to the automatic experimental system selected by the user of terminal device 400. In S14, the controller of the automatic experimental system automatically executes the experimental protocol received from server device 200. In step S15, the controller transmits the output data of the processing included in the experimental protocol to server device 200. In step S16, server device 200 updates the parameters related to the amount of the content in the experimental container in experimental protocol management application 900.

### First Modification

The embodiment has been described with regard to the case where the experimental protocol designed in the terminal device is transmitted to the automatic experimental system through the server device. The experimental protocol may be directly transmitted from the terminal device to the automatic experimental system.

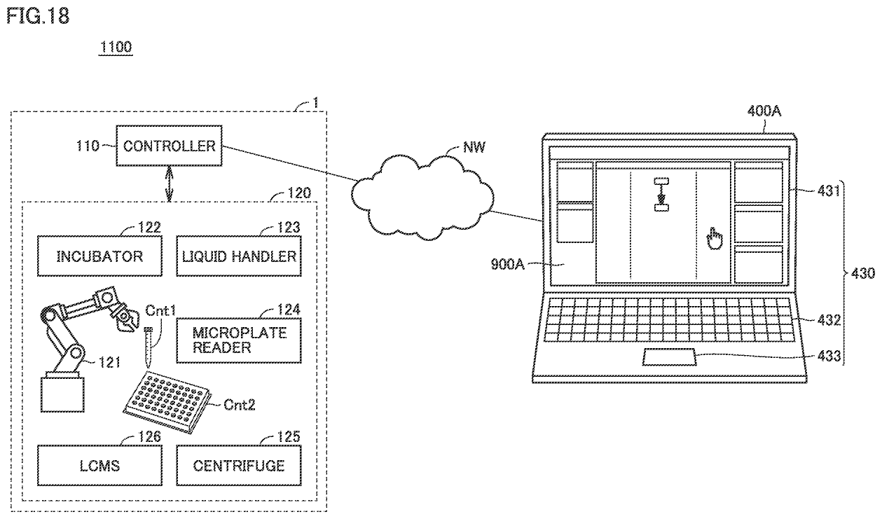

FIG. 18 is a block diagram illustrating a configuration of an automatic experimental management system 1100 according to a first modification of the embodiment. The configuration of automatic experimental management system 1100 is a configuration in which server device 200 and database 300 are excluded from automatic experimental management system 1000 in FIG. 1 and terminal device 400 is replaced with a terminal device 400A. Since other configurations are the same, the description thereof will not be repeated. An experimental protocol management application 900A is displayed on display 431 of terminal device 400A.

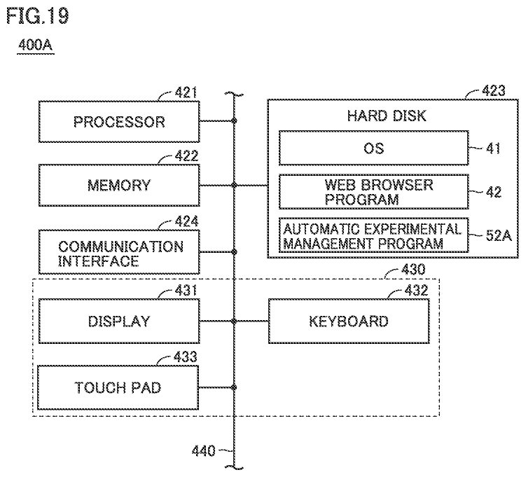

FIG. 19 is a block diagram illustrating a hardware configuration of terminal device 400A in FIG. 18. The configuration of terminal device 400A is a configuration in which an automatic experimental management program 52A is added to hard disk 423 in FIG. 2. Since other configurations are the same, the description thereof will not be repeated. When automatic experimental management program 52A is executed by processor 421, the automatic execution of the experimental protocol by experimental protocol management application 900A and the automatic experimental system is implemented.

### Second Modification

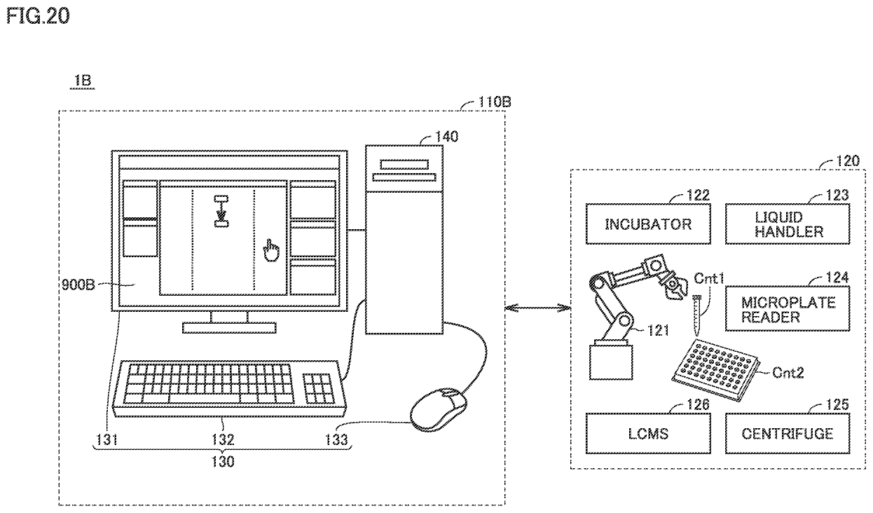

The experimental protocol may be designed in the controller of the automatic experimental system. FIG. 20 is a block diagram illustrating a configuration of an automatic experimental system 1B according to the second modification of the embodiment. The configuration of automatic experimental system 1B is a configuration in which controller 110 is replaced with a controller 110B in automatic experimental system 1 in FIG. 1. Since other configurations are the same, the description thereof will not be repeated.

As illustrated in FIG. 20, controller 110B includes an input and output unit 130 and a computer 140 (a processing unit). Input and output unit 130 includes a display 131 (a display unit), a keyboard 132 (an input unit), and a mouse 133 (an input unit). Display 131, keyboard 132, and mouse 133 are connected to computer 140. Display 131 shows a GUI of an experimental protocol management application 900B. Keyboard 132 and mouse 133 receive the GUI operation on experimental protocol management application 900B by the user. That is, the user performs the desired GUI operation on experimental protocol management application 900B by the operation to manipulate keyboard 132 or mouse 133 while referring to the indication shown on display 131.

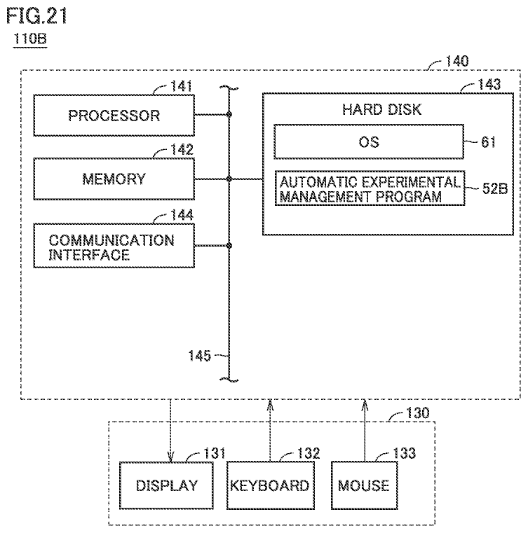

FIG. 21 is a block diagram illustrating a hardware configuration of controller 110B in FIG. 20. As illustrated in FIG. 21, computer 140 includes a processor 141, a memory 142 and a hard disk 143 as a storage unit, and a communication interface 144. These are communicably connected to each other through a bus 145.

Hard disk 143 is a non-volatile storage device. For example, a program 61 of an operating system (OS) and an automatic experimental management program 52B (a specific program) are stored in hard disk 143. In addition to the data shown in FIG. 21, for example, settings and outputs of various applications are stored in hard disk 143. Memory 142 is typically a volatile storage device such as a dynamic random access memory (DRAM).

Processor 141 includes a central processing unit (CPU). Processor 141 reads a program stored in hard disk 143 into memory 142 and executes the program. Automatic experimental management program 52B is executed by processor 141 to thereby implement the automatic execution of the experimental protocol by experimental protocol management application 900B and the plurality of experimental devices 120. Processor 141 is connected to a network through communication interface 144.

As described above, the method and the system according to the embodiment and the first modification, and the device according to the second modification of the embodiment make it possible to improve the efficiency of the automatic execution of the experimental protocol.

### Aspects

It is understood by those skilled in the art that the exemplary embodiment described above provides specific examples of the following aspects.

### Item 1

A method according to an aspect is to manage an experimental protocol through a specific application executed in a terminal device. The method includes the steps of: setting a first parameter of the specific application according to an amount of a sample contained in a specific container used in the experimental protocol; setting a second parameter of the specific application according to a change in the amount of the sample in specific processing using the specific container in the experimental protocol; controlling an experimental device to automatically execute the experimental protocol based upon the first parameter and the second parameter; and updating the first parameter based upon the second parameter after the specific processing ends.

In the method described in the first aspect, after execution of the specific processing of the experimental protocol, the content is automatically updated according to a change in the amount of the content in the specific container in the specific processing. According to the present method, there is no need for the user to update the amount of the content in the specific container one by one each time the experimental protocol ends, and thus, the efficiency of the automatic execution of the experimental protocol can be improved.

### Item 2

In the method according to Item 1, the specific container includes a plurality of sample accommodation spaces. The step of setting the first parameter includes setting the first parameter at an amount of a sample contained in each of the plurality of sample accommodation spaces.

According to the method described in Item 2, the amount of the sample can be set in each of the sample accommodation spaces included in the specific container.

### Item 3

The method according to Item 1 further includes the step of designing the experimental protocol in a form of an oriented graph including a specific node corresponding to the specific processing based on a GUI operation by a user on the specific application. The step of setting the second parameter is performed through a specific GUI displayed according to the GUI operation by the user on the specific node.

According to the method described in Item 3, the processing included in the experimental protocol is represented as a specific node included in the oriented graph, and thereby, the change in the amount of the content in the experimental container can be readily set through the specific GUI displayed by the GUI operation performed on the specific node.

### Item 4

In the method according to Item 3, a plurality of nodes each selectable as a vertex of the oriented graph includes a processing node corresponding to processing by the experimental device, and a container node corresponding to a container accommodating a sample to be processed by the experimental device. The step of designing the experimental protocol includes automatically adding the container node according to addition of the processing node, and the container node and the processing node are connected by an edge extending from the container node to the processing node.

According to the method described in Item 4, in the experimental protocol designed as an oriented graph, the container node corresponding to the experimental container and the processing node corresponding to the processing using the experimental container are connected by the edge, and thereby, the correspondence relation between the experimental container and the processing using the experimental container can be readily grasped.

### Item 5

A system according to an aspect manages an experimental protocol. The system includes an experimental device, a terminal device, and a controller. The terminal device executes a specific application. The controller controls the experimental device. The specific application sets a first parameter of the specific application according to an amount of a sample contained in a specific container used in the experimental protocol. The specific application sets a second parameter of the specific application according to a change in the amount of the sample in specific processing using the specific container in the experimental protocol. The controller automatically executes the experimental protocol based upon the first parameter and the second parameter. The specific application updates the first parameter based upon the second parameter.

In the system described in Item 5, after execution of the specific processing of the experimental protocol, the content in the specific container in the specific processing is automatically updated according to a change in the amount of this content in the specific container. According to the present system, there is no need for the user to update the amount of the content in the specific container one by one each time the experimental protocol ends, and thereby, the efficiency of the automatic execution of the experimental protocol can be improved.

### Item 6

The system according to Item 5 further includes a server device. The server device provides the specific application to the terminal device. The server device transmits the experimental protocol designed by the terminal device to the controller.

According to the system described in Item 6, the server device is interposed between the terminal device that designs the experimental protocol and the controller that controls the experimental device to execute the experimental protocol, and thereby, the server device can collectively manage a plurality of terminal devices and a plurality of controllers.

### Item 7

A device according to an aspect manages an experimental protocol through a specific application. The device includes a storage unit and a processing unit. The storage unit stores a specific program that implements the specific application. The processing unit executes the specific program. The processing unit sets a first parameter of the specific application according to an amount of a sample contained in a specific container used in the experimental protocol. The processing unit sets a second parameter of the specific application according to a change in the amount of the sample in specific processing using the specific container in the experimental protocol. The processing unit controls an experimental device to automatically execute the experimental protocol based upon the first parameter and the second parameter. The processing unit updates the first parameter based upon the second parameter after the specific processing ends.

In the device described in Item 7, after execution of the specific processing of the experimental protocol, the content in the specific container in the specific processing is automatically updated according to a change in the amount of this content in the specific container. According to the present device, there is no need for the user to update the amount of the content in the specific container one by one each time the experimental protocol ends, and thereby, the efficiency of the automatic execution of the experimental protocol can be improved.

For the above-described embodiment and modifications thereof, it is initially intended at the time of filing of the application to appropriately combine the configurations described in the embodiment, including any combination not mentioned in the specification, within a range free of inconsistency or contradiction.

It should be understood that the embodiment disclosed herein is illustrative and non-restrictive in every respect. The scope of the present invention is defined by the scope of the claims, rather than the description above, and is intended to include any modifications within the meaning and scope equivalent to the scope of the claims.

### REFERENCE SIGNS LIST

1, 1B automatic experimental system, 41, 42, 51, 61 program, 52, 52A, 52B automatic experimental management program, 110, 110B controller, 120 experimental device, 121 robot arm, 122 incubator, 123 liquid handler, 124 microplate reader, 125 centrifuge, 130, 205, 430 input and output unit, 131, 431 display, 132, 432 keyboard, 133 mouse, 140 computer, 141, 201, 421 processor, 142, 202, 422 memory, 143, 203, 423 hard disk, 144, 204, 424 communication interface, 145, 210, 440 bus, 200 server device, 300 database, 400, 400A terminal device, 433 touch pad, 500 experimental protocol design module, 510 queue list window, 520 protocol list window, 530 protocol design window, 531 container region, 532 processing region, 533 data region, 540 automatic experimental system window, 550 experimental container window, 560 change-in-amount-of-sample setting window, 600 browser, 700 experimental container management module, 710 experimental container information window, 720 physical position window, 730 sample setting window, 731 addition button, 732 delete button, 733 reference button, 740 sample accommodation space window, 800 sample information setting window, 810 basic information window, 811 combo box, 812 to 816 edit box, 820 strain window, 900, 900A, 900B experimental protocol management application, 1000, 1100 automatic experimental management system, C1, C2 container node, Cnt1 tube, Cnt2 microplate, Cr selection cursor, D1, D2 data node, DG oriented graph, E1, E2, E10 to E17, E21 to E27, E31, E32 edge, In1, In2, Lq1 to Lq3 position, M1 to M6 processing node, Me end node, Ms start node, NW network, p1 to p3 experimental protocol, q1, q2 queue.

1. A method for managing an experimental protocol through a specific application executed in a terminal device, the method comprising the steps of:
setting a first parameter of the specific application according to an amount of a sample contained in a specific container used in the experimental protocol;
setting a second parameter of the specific application according to a change in the amount of the sample in specific processing using the specific container in the experimental protocol;
controlling an experimental device to automatically execute the experimental protocol based upon the first parameter and the second parameter; and
updating the first parameter based upon the second parameter after the specific processing ends.

2. The method according to claim 1, wherein
the specific container includes a plurality of sample accommodation spaces, and
the step of setting the first parameter includes setting the first parameter at an amount of a sample contained in each of the plurality of sample accommodation spaces.

3. The method according to claim 1, further comprising the step of designing the experimental protocol in a form of an oriented graph including a specific node corresponding to the specific processing based on a GUI operation by a user on the specific application, wherein
the step of setting the second parameter is performed through a specific GUI displayed according to the GUI operation by the user on the specific node.

4. The method according to claim 3, wherein
a plurality of nodes each selectable as a vertex of the oriented graph includes a processing node corresponding to processing by the experimental device, and a container node corresponding to a container accommodating a sample to be processed by the experimental device,
the step of designing the experimental protocol includes automatically adding the container node according to addition of the processing node, and
the container node and the processing node are connected by an edge extending from the container node to the processing node.

5. A system for managing an experimental protocol, the system comprising:
an experimental device;
a terminal device that executes a specific application; and
a controller that controls the experimental device, wherein
the specific application
sets a first parameter of the specific application according to an amount of a sample contained in a specific container used in the experimental protocol, and
sets a second parameter of the specific application according to a change in the amount of the sample in specific processing using the specific container in the experimental protocol,
the controller automatically executes the experimental protocol based upon the first parameter and the second parameter, and
the specific application updates the first parameter based upon the second parameter.

6. The system according to claim 5, further comprising a server device that provides the specific application to the terminal device, wherein
the server device transmits the experimental protocol designed by the terminal device to the controller.

7. A device for managing an experimental protocol through a specific application, the device comprising:
a storage unit that stores a specific program that implements the specific application; and
a processing unit that executes the specific program, wherein
the processing unit
sets a first parameter of the specific application according to an amount of a sample contained in a specific container used in the experimental protocol,
sets a second parameter of the specific application according to a change in the amount of the sample in specific processing using the specific container in the experimental protocol,
controls an experimental device to automatically execute the experimental protocol based upon the first parameter and the second parameter, and
updates the first parameter based upon the second parameter after the specific processing ends.
